(19) United States
(12) Patent Application Publication
(10) Pub. No.: US 2023/0359871 A1
(43) Pub. Date: Nov. 9, 2023

(54) CONVOLUTIONAL NEURAL NETWORK ACCELERATION METHOD AND SYSTEM BASED ON CORTEX-M PROCESSOR, AND MEDIUM

(71) Applicant: HANGZHOU VANGO TECHNOLOGIES, INC., Hangzhou (CN)

(72) Inventors: Yang REN, Hangzhou (CN); Honglei LIANG, Hangzhou (CN); Changyou MEN, Hangzhou (CN); Junhu XIA, Hangzhou (CN); Nianxiong Tan, Hangzhou (CN)

(73) Assignee: HANGZHOU VANGO TECHNOLOGIES, INC., Hangzhou (CN)

(21) Appl. No.: 18/011,530

(22) PCT Filed: Feb. 25, 2022
(86) PCT No.: PCT/CN2022/077862

§ 371 Date: Dec. 20, 2022

(30) Foreign Application Priority Data
Dec. 29, 2021 (CN) 202111638233.0

(51) Int. Cl. G06N 3/0464

(52) U.S. Cl. CPC G06N 3/0464

(57) ABSTRACT

The application relates to a convolutional neural network acceleration method and system based on a Cortex-M processor, and a medium. The method comprises: setting a MCR instruction and a CDP instruction according to common basic operators of a convolutional neural network, the common basic operators comprising a convolution operator, a Relu activation operator, a pooling operator, a table look-up operator and a quantization operator; and configuring an internal register of a convolutional neural network coprocessor through the MCR instruction, and then enabling the common basic operators of the convolutional neural network through the CDP instruction. Through the application, problems of inefficiency, high cost and inflexibility of a cyclic neural network algorithm in the execution of a processor are solved, and the basic operators needed for the cyclic neural network to be executed through a coprocessor instruction set are realized.

### TECHNICAL FIELD

The present application relates to the technical field of deep learning, and more particularly, to a convolutional neural network acceleration method and system based on a Cortex-M processor, and a medium.

### BACKGROUND

With the continuous development of science and technology, artificial intelligence technology is continuously integrated into the daily life of people, and the application of target detection, speech recognition and the like enables the society to operate more efficiently and orderly, for example, ImageNet applied to image recognition realizes the object recognition accuracy higher than that of human eyes. The convolutional neural network CNN is used as one of artificial neural networks, does not need to manually select characteristics or determine an input and output relationship, and can automatically acquire characteristics of original data so as to obtain a mapping relationship between input and the output. The basic operations in the convolutional neural network include convolution, pooling, vector operations, and Relu activation.

Aiming at the bandwidth cost and delay problems of long-distance transmission of mass data in cloud computing, more and more edge devices start to support related operations (such as convolution, activation, pooling and the like) of the convolutional neural network, and besides the operations are directly performed by using a central processing unit of a MCU, various convolutional neural network hardware accelerators equipped on the MCU are also designed to perform specific operation acceleration. However, the typical micro control unit MCU cannot perform such huge data operations, which results in long inference time at an end side. Dedicated hardware accelerator architectures are fixed and inflexible, and tailoring hardware accelerators to formally diverse algorithms increases development costs.

Currently, no effective solution has been proposed for the problems of inefficiency, high cost and inflexibility in processor execution of convolutional neural network algorithms in the related art.

### SUMMARY

Embodiments of the present application provide a convolutional neural network acceleration method and system based on a Cortex-M processor, and a medium to at least solve the problems of inefficiency, high cost, and inflexibility of convolutional neural network algorithms in processor execution in the related art.

According to a first aspect, an embodiment of the present application provides a convolutional neural network acceleration method based on a Cortex-M processor, wherein the method includes:
setting a MCR instruction and a CDP instruction according to common basic operators of a convolutional neural network, wherein the common basic operators include a convolution operator, a Relu activation operator, a pooling operator, a table look-up operator and a quantization operator; and
configuring an internal register of a convolutional neural network coprocessor through the MCR instruction, and then enabling the common basic operators of the convolutional neural network through the CDP instruction.

In some embodiments, the step of configuring the internal register of the convolutional neural network coprocessor through the MCR instruction includes:
configuring a data address, stride block information and format information of the internal register of the convolutional neural network coprocessor through the MCR instruction, wherein the data address is used for reading and writing data in operation, the stride block information is used for partitioning data in operation, and the format information is used for confirming an operation format and a write-back format of data.

In some embodiments, the step of configuring the internal register through the MCR instruction, and then enabling the common basic operators through the CDP instruction, includes:
configuring a local buffer address of a convolution kernel to a first register, configuring a local buffer address of feature data to a second register, configuring stride block information to a scale register, and configuring format information to a control register through a first MCR instruction;
enabling the convolution operator through the CDP instruction, and determining a preset channel number and a preset number of sets of the feature data in each operation according to the stride block information;
sequentially performing Multiply Accumulate operations on the feature data and the convolution kernel in a channel direction according to a total channel number and the preset channel number of the feature data; and
sequentially performing Multiply Accumulate operations on the feature data and the convolution kernel in each channel of the feature data in a preset direction according to the total number of sets and the preset number of sets of the feature data, and the format information until convolution results of all channels are obtained.

In some embodiments, the step of configuring the internal register through the MCR instruction, and then enabling the common basic operators through the CDP instruction, further includes:
configuring a local buffer address of input data to a first register, configuring a local buffer address of write-back information to a second register, and configuring stride block information to a scale register through a second MCR instruction;
enabling the Relu activation operator of the convolutional neural network through the CDP instruction, inputting the input data to a Relu activation function

$$Relu ( X ) = \{ \begin{matrix}0 , & x < 0 \\ x , & x \geq 0\end{matrix}$$

according to the stride block information, and returning a result value; and
writing the result value back to a local buffer according to the write-back information.

In some embodiments, the step of configuring the internal register through the MCR instruction, and then enabling the common basic operators through the CDP instruction, further includes:
configuring a local buffer address of a first vector set to a first register, configuring a local buffer address of a second vector set to a second register, configuring a local buffer address of write-back information to a third register, and configuring stride block information to a scale register through a third MCR instruction;
enabling the pooling operator of the convolutional neural network through the CDP instruction, comparing values in the first vector set and the second vector set one by one according to the stride block information, and returning a vector with a larger value from each comparison; and
writing a maximum pooling result obtained by the comparison back to a local buffer according to the write-back information.

In some embodiments, the step of configuring the internal register through the MCR instruction, and then enabling the common basic operators through the CDP instruction, further includes:
configuring a local buffer address of input data to a first register, configuring a local buffer address of write-back information to a second register, and configuring stride block information and table base address information to a scale register through a fourth MCR instruction;
enabling the table look-up operator of the convolutional neural network through the CDP instruction, and performing a table look-up operation according to the input data, the stride block information and the table base address information; and
writing a table look-up result back to a local buffer according to the write-back information.

In some embodiments, the step of configuring the internal register through the MCR instruction, and then enabling the common basic operators through the CDP instruction, further includes:
configuring a local buffer address of input data to a first register, configuring a local buffer address of write-back information to a second register, and configuring stride block information to a scale register through a second MCR instruction; and
enabling the quantization operator of the convolutional neural network through the CDP instruction, and converting a 32-bit single-precision floating-point number conforming to an IEEE-754 standard in the input data into a 16-bit integer according to the stride block information, or converting a 16-bit integer in the input data into a 32-bit single-precision floating-point number conforming to the IEEE-754 standard; and writing a conversion result back to a local buffer according to the write-back information.

In some embodiments, the method further includes:
configuring a main memory address to a first register, configuring a local buffer address to a second register, and configuring stride block information to a scale register through a fifth MCR instruction;
enabling a data reading operation through the CDP instruction, and reading data in the main memory address to a local buffer according to the stride block information; and
enabling a data writing operation through the CDP instruction, and writing the data in the local buffer to the main memory address according to the stride block information.

According to a second aspect, an embodiment of the present application provides a convolutional neural network acceleration system based on a Cortex-M processor, wherein the system includes an instruction set setting module and an instruction set execution module;
the instruction set setting module sets a MCR instruction and a CDP instruction according to common basic operators of a convolutional neural network, wherein the common basic operators include a convolution operator, a Relu activation operator, a pooling operator, a table look-up operator and a quantization operator; and
the instruction set execution module configures an internal register of a convolutional neural network coprocessor through the MCR instruction, and then enables the common basic operators of the convolutional neural network through the CDP instruction.

According to a third aspect, an embodiment of the present application provides computer-readable storage medium storing a computer program thereon, wherein the program, when executed by a processor, implements the convolutional neural network acceleration method based on the Cortex-M processor according to the first aspect above.

Compared with the related art, the convolutional neural network acceleration method and system based on the Cortex-M processor, and the medium provided by the embodiments of the present application set the MCR instruction and the CDP instruction according to the common basic operators of the convolutional neural network, wherein the common basic operators include the convolution operator, the Relu activation operator, the pooling operator, the table look-up operator and the quantization operator; and configure the internal register of the convolutional neural network coprocessor through the MCR instruction, and enable the common basic operators of the convolutional neural network through the CDP instruction. Through the application, the problems of inefficiency, high cost and inflexibility of the convolutional neural network in the execution of the processor are solved, and (1) the basic operators needed to execute the convolutional neural network through the coprocessor instruction set are realized, and the cost of hardware reconstruction can be reduced for the application fields with variable algorithms; (2) by extracting the data from the local buffer through the coprocessor instruction set, the reuse rate of the local buffer data is improved, and the bandwidth demand of the coprocessor accessing the main memory is reduced, thus reducing the power consumption and cost of the whole system; (3) using the coprocessor to handle artificial intelligence operations and specifically transmitting instructions through a dedicated coprocessor interface for a CPU can avoid a delay problem caused by bus congestion and improve the system efficiency; and (4) the coprocessor instruction set in the present invention has flexible design and large reserved space, which is convenient to add additional instructions when upgrading hardware.

### BRIEF DESCRIPTION OF THE DRAWINGS

The accompanying drawings illustrated herein serve to provide a further understanding of the present application and constitute a part of the present application, and the illustrative embodiments of the present application and together with the description thereof serve to explain the present application, and do not constitute inappropriate limitation to the present application. In the drawings:

FIG. 1 is a flow chart of steps of a convolutional neural network acceleration method based on a Cortex-M processor according to an embodiment of the present application;

FIG. 2 is a flow chart of steps for executing a convolution operator through a MCR instruction and a CDP instruction;

FIG. 3 is a specific flow chart for executing the convolution operator through the MCR instruction and the CDP instruction;

FIG. 4 is a schematic diagram of a specific Multiply Accumulate operation without a write-back function;

FIG. 5 is a structural block diagram of the convolutional neural network acceleration method based on the Cortex-M processor according to an embodiment of the present application;

and

FIG. 6 is a schematic diagram of an internal structural diagram of an electronic device according to an embodiment of the present application.

Numeral references: 51 refers to instruction set setting module; and 52 refers to instruction set execution module.

### DETAILED DESCRIPTION OF THE EMBODIMENTS

To make the objectives, technical solutions, and advantages of the present application clearer, the following describes and illustrates the present application with reference to the accompanying drawings and embodiments. It should be understood that the specific embodiments described herein are merely illustrative of the present application and are not intended to limit the present application. Based on the embodiments provided by the present application, all other embodiments obtained by those of ordinary skills in the art without going through any creative effort shall fall within the scope of protection of the present application.

It is obvious that the accompanying drawings in the following description are only examples or embodiments of the present application, and that it is also possible for those of ordinary skills in the art to apply the application to other similar contexts on the basis of these accompanying drawings without inventive effort. Moreover, it may also be understood that although the efforts made in the development process may be complicated and lengthy, for those of ordinary skills in the art related to the contents disclosed in the present application, some changes in design, manufacture or production based on the technical contents disclosed in the present application are only conventional technical means, and should not be understood as the contents disclosed in the present application are insufficient.

Reference in the specification to “an embodiment” means that a particular feature, structure, or characteristic described in connection with the embodiment may be included in at least one embodiment of the present application. The appearances of the phrase in various places in the specification are not necessarily all referring to the same embodiment, nor are separate or alternative embodiments mutually exclusive of other embodiments. It is to be expressly and implicitly understood by those of ordinary skills in the art that the embodiments described herein may be combined with other embodiments without conflict.

Unless otherwise defined, the technical terms or scientific terms involved in the present application should have general meanings understood by those of ordinary skills in the technical field to which the present application belongs. The use of the terms “a”, “an”, “a/an” and “the” and similar referents in the context of describing the present application (including a single reference) are to be construed in a non-limiting sense as indicating either the singular or the plural. The term “comprise”, “include” and “provided with” and any variations thereof involved in the present application are intended to cover non-exclusive inclusion. For example, processes, methods, systems, products or devices including a series of steps or modules (units) are not limited to the listed steps or units, but may further include steps or units not listed, or may further include other steps or units inherent to these processes, methods, products or devices. “Connection”, “connected”, “couple” and similar terms involved in the present application are not limited to a physical or mechanical connection, but may include an electrical connection, regardless of a direct or indirect connection. “A plurality” involved in the present application means two or more. “And/or” describes an association relationship of associated object, indicating that there may be three relationships, for example, “A and/or B” may indicate: these three cases including only A, both A and B, and only B. The character “/” generally indicates that the contextual objects are in an “or” relationship. The terms “first”, “second”, “third” and the like involved in the present application are used to distinguish similar objects only, and do not represent specific ordering for objects.

In the prior art, the simplest approach is to process the calculations of these convolutional neural networks directly using a processor of a MCU. The existing ARM Cortex-M series processor includes a series of independent operation instructions such as addition, multiplication and accumulation and the like, may be used for a small amount of operation, and is low in efficiency when the processor is used for processing mass data operation due to the fact that parallel calculation cannot be carried out. For example, processing the most basic Multiply Accumulate in convolution operation requires at least ten instructions, and if a complete lenet-5 network is calculated, ten thousand instructions are used, which is difficult for an edge device to satisfy the real-time requirement. Meanwhile, a large amount of operations occupy the resources of the processor, and further influence the overall performance of the system.

On one hand, a dedicated hardware accelerator is designed to process these operations, the operation with the largest operation amount in the convolutional neural network is the convolution operation, and a method for constructing a dedicated deep learning accelerator by utilizing an application specific integrated circuit ASIC has a certain effect, but a special hardware structure is designed according to different requirements, the original hardware structure cannot necessarily meet the latest algorithm requirement at present when artificial intelligence algorithms are in the endlessly, and the repeated customization of hardware may increase the cost.

On the other hand, if a cloud computing method is used, the bandwidth cost and delay problem of long-distance transmission may be caused, in some occasions with high real-time requirements, such as using deep learning in industry to detect the occurrence of electric arcs, the electric arcs need to be recognized as soon as possible and a power supply needs to be cut off so as to protect electric equipment, and dangers may be increased due to excessive delay, so the cloud computing solution has certain limitations.

Therefore, in order to realize a convolutional neural network accelerator with certain flexibility, the present invention provides an efficient, simple and flexible instruction set of a convolutional neural network coprocessor, which omits unnecessary operations to achieve the aim of light weight, can realize convolution, activation, pooling, element vector operation and quantization operators, and can realize the support of different convolutional neural network algorithms under the condition of not redesigning a hardware structure.

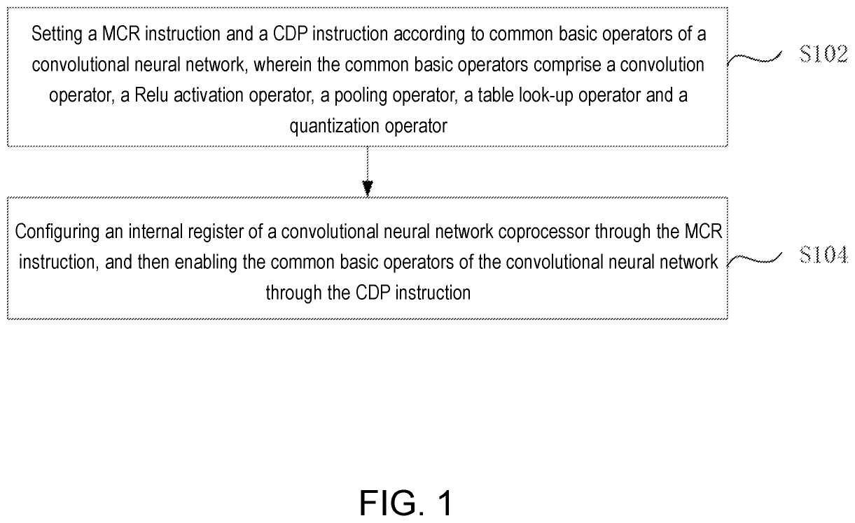

An embodiment of the present application provides a convolutional neural network acceleration method based on a Cortex-M processor. FIG. 1 is a flow chart of steps of the convolutional neural network acceleration method based on the Cortex-M processor according to the embodiment of the present application. As shown in FIG. 1, the method includes the following steps.

At step S102, a MCR instruction and a CDP instruction are set according to common basic operators of a convolutional neural network, wherein the common basic operators include a convolution operator, a Relu activation operator, a pooling operator, a table look-up operator and a quantization operator.

Specifically, Table 1 shows a set of partial CDP instructions of a convolutional neural network coprocessor. As shown in Table 1, each CDP instruction corresponds to two operands and a corresponding instruction function.

TABLE 1

| Oper- | Oper- | |
|---|---|---|
| and 1 | and 2 | Instruction function |
| 0000 | 000 | Operation of reading main memory data to local |
| | | buffer operation |
| 0000 | 001 | Operation of writing the local buffer data to the |
| | | main memory |
| 0001 | 011 | Multiply Accumulate operation without write-back |
| | | function |
| 0001 | 111 | Multiply Accumulate operation with write-back |
| | | function |
| 0010 | 001 | Element vector Multiply operation |
| 0010 | 010 | Element vector comparison operation |
| 0011 | 001 | Relu activation operation |
| 0011 | 010 | Operation of converting from 32-bit single-precision |
| | | floating-point number (FP32) to 16-bit integer |
| | | number (INT16) |
| 0011 | 011 | Operation of converting from 16-bit integer (INT16) |
| | | to 32-bit single-precision floating-point number |
| | | (FP32) |
| 0100 | 000 | Table look-up operation with a table entry of 64 |
| 0100 | 001 | Table look-up operation with a table entry of 128 |
| 0100 | 010 | Table look-up operation with a table entry of 256 |
| 0100 | 011 | Table look-up operation with a table entry of 512 |

At step S104, an internal register of a convolutional neural network coprocessor is configured through the MCR instruction, and then the common basic operators of the convolutional neural network are enabled through the CDP instruction.

Specifically, a data address, stride block information and format information of the internal register of the convolutional neural network coprocessor are configured through the MCR instruction, wherein the data address is used for reading and writing data in operation, the stride block information is used for partitioning data in operation, and the format information is used for confirming an operation format and a write-back format of data.

Then, the common basic operators of the convolutional neural network are enabled by using the CDP instruction in Table 1.

Through the step S102 to the step S104 in the embodiment of the present application, the problems of inefficiency, high cost and inflexibility of convolutional neural network algorithms in the execution of the processor are solved. The basic operators needed to execute the convolutional neural network through the coprocessor instruction set are realized, and the cost of hardware reconstruction can be reduced for the application fields with variable algorithms. By extracting the data from the local buffer through the coprocessor instruction set, the reuse rate of the local buffer data is improved, and the bandwidth demand of the coprocessor accessing the main memory is reduced, thus reducing the power consumption and cost of the whole system. Using the coprocessor to handle artificial intelligence operations and specifically transmitting instructions through a dedicated coprocessor interface for a CPU can avoid a delay problem caused by bus congestion and improve the system efficiency. The coprocessor instruction set has flexible design and large reserved space, which is convenient to add additional instructions when upgrading hardware.

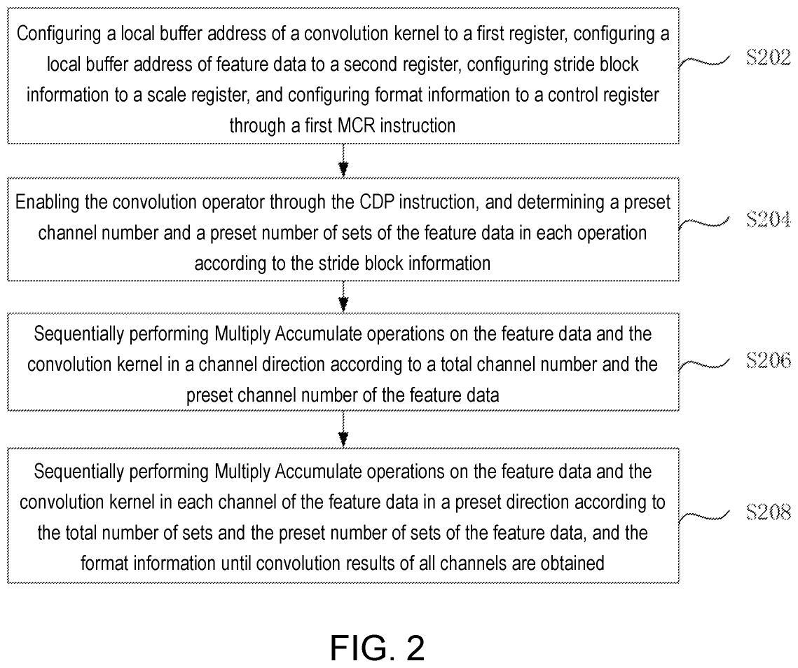

In some embodiments, FIG. 2 is a flow chart of the steps of executing the convolution operators through the MCR instruction and the CDP instruction. As shown in FIG. 2, the step S104 of configuring the internal register through the MCR instruction, and then enabling the common basic operators through CDP instruction, specifically includes the following steps.

At step S202, a local buffer address of a convolution kernel is configured to a first register, a local buffer address of feature data is configured to a second register, stride block information is configured to a scale register, and format information is configured to a control register through a first MCR instruction.

Specifically, the local buffer address of the convolution kernel (weight data) is configured to a DLA_ADDR1 register through the first MCR instruction; the local buffer address of the feature data is configured to a DLA_ADDR2 register; a stride block number and a stride block interval are configured to a DLA_SIZE register; and an operation mode and the write-back precision are configured to a DLA_Control register.

The stride block information includes the stride block number, the stride block interval and a stride block size, wherein the stride block number is DLA_SIZE[15:0], which indicates the number of sets of the feature data; and the stride block interval is DLA_SIZE[23:16], which indicates the interval between each set of feature data, with a granularity of 128 Bits (16 Bytes), indicates continuous access when it is configured to 0; otherwise, the actual stride size is (DLA_SIZE[23:16]+1)*16 bytes. The stride block size is fixed at 128 Bits (16 Bytes). Therefore, the feature data of this operation is the stride block number*the stride block size, that is, DLA_SIZE[15:0]*16 Bytes. In addition, a number of the convolution kernel (weight data) of each operation is fixed at 512 Bits (64 Bytes).

The operation mode is DLA_Control[0], which indicates that a Multiply Accumulate unit is in the mode of 8-bite integer multiplication and 16-bit integer addition (INT8*INT8+INT16) when it is configured as 0, and indicates that the Multiply Accumulate unit is in the mode of 16-bit integer multiplication and 32-bit integer addition (INT16*INT16+INT32) when it is configured as 1. The write-back precision is DLA_Control[1], which writes back with 8 bits in the operation mode 0 and written back with 16 bits in the operation mode 1 when it is configured as 0; and writes back with 16 bits in the operation mode 0 and written back with 32 bits in the operation mode 1 when it is configured as 1.

At step S204, the convolution operator is enabled through the CDP instruction, and a preset channel number and a preset number of sets of the feature data in each operation are determined according to the stride block information.

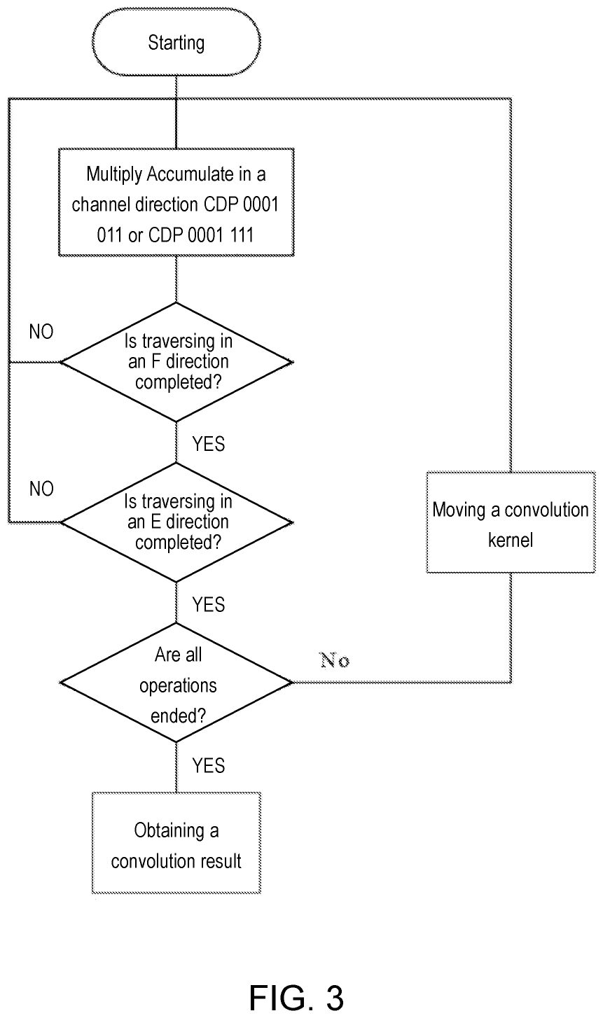

Specifically, FIG. 3 is a specific flow chart for executing the convolution operator through the MCR instruction and the CDP instruction. As shown in FIG. 3, the operation in the convolution operator is essentially the Multiply Accumulate operations of the convolution kernel and the feature data. The convolution operator is enabled through a CDP 0001 011 instruction or a CDP 0001 111 instruction. Because an amount of data calculated by a single Multiply Accumulate instruction of the coprocessor is limited, it is necessary to split the total convolution operation, so as to conform to the working mode of hardware. The preset channel number of the feature data in each operation after splitting is determined according to the stride block size, and the number of sets of the feature data in each operation is determined according to the stride block number.

At step S206, Multiply Accumulate operations are sequentially performed on the feature data and the convolution kernel in a channel direction according to a total channel number and the preset channel number of the feature data.

Specifically, as shown in FIG. 3, the Multiply Accumulate operations are sequentially performed on the feature data and the convolution kernel in the channel direction according to the total channel number and the preset channel number of the feature data. For example, the preset channel number for each operation is 8, and the total channel number is 128, so it is necessary to sequentially perform the Multiply Accumulate operations on the feature data and the convolution kernel for 16 times in the channel direction.

At step S208, Multiply Accumulate operations on the feature data and the convolution kernel are sequentially performed in each channel of the feature data in a preset direction according to the total number of sets and the preset number of sets of the feature data, and the format information until convolution results of all channels are obtained.

Specifically, as shown in FIG. 3, in each channel of the feature data, traversing is performed in an F direction first, and the maximum number of sets of the feature data for the Multiply Accumulate operation is 16. It is provided that the total number of sets of the feature data (horizontal size) is 32, it is necessary to perform the Multiply Accumulate operation for twice, and traversing is performed in an E direction after the cycle in the F direction. The CDP 0001 111 instruction is used in the last Multiply Accumulate operation to write the arithmetic result of the current operation back to a local buffer, move the convolution kernel, and repeat the above convolution operations until the convolution results of all channels are obtained.

In addition, it should be noted that the convolution operator (Multiply Accumulate operation) enabled through the CDP 0001 011 instruction has no write-back function, that is, the obtained results may be stored in a temporary buffer instead of being written back to the local buffer, and may be used as initial values of next Multiply Accumulate operation.

The specific examples are as follows.

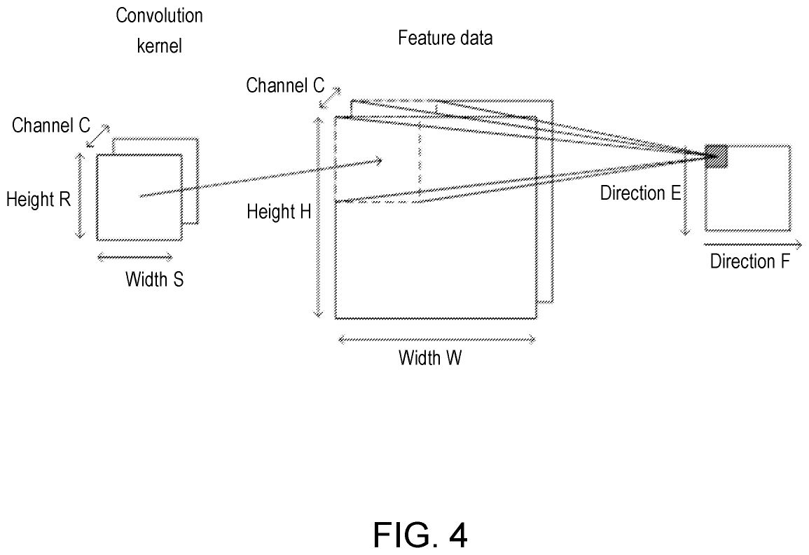

FIG. 4 is a schematic diagram of a specific Multiply Accumulate operation without a write-back function. FIG. 4 shows the operation process in the case that the operation mode DLA_Control[0] is configured as 1 (INT16*INT16+INT32), and the write-back precision is configured as 0 (16 bits), wherein the local buffer has a width of 16 bits. Therefore, each address corresponds to one 16 bits data.

Each operation may take 64 Bytes of weight data from the given address of the weight data, that is, 32 numbers (16 bits for each data), and take several sets of feature data with granularity of 16 Bytes (up to 16 sets, that is, 256 Bytes) from the initial address of the feature data. Each set (8 numbers) of feature data may be multiplied by the weight data of 64 Bytes in sequence and then added, and four intermediate results may be obtained, and finally [4*number of feature data sets] intermediate results are obtained, and the obtained intermediate results are stored in the temporary buffer and sued as the initial value of next multiply and accumulate operation.

Preferably, an overflow mode may also be configured to the DLA_Control register through the first MCR instruction. After the configuration, the CDP 0001 111 instruction may be used to enable the convolution operator (Multiply Accumulate operation) with the write-back function, and write the final calculation result from the temporary buffer back to the local buffer.

In some embodiments, the step S104 of configuring the internal register through the MCR instruction, and then enabling the common basic operators through the CDP instruction, further includes:
configuring a local buffer address of input data to a first register, configuring a local buffer address of write-back information to a second register, and configuring stride block information to a scale register through a second MCR instruction;
enabling the Relu activation operator of the convolutional neural network through the CDP instruction, inputting the input data to a Relu activation function

$$Relu ( X ) = \{ \begin{matrix}0 , & x < 0 \\ x , & x \geq 0\end{matrix}$$

according to the stride block information, and returning a result value; and
writing the result value back to a local buffer according to the write-back information.

Specifically, the local buffer address of the input data is configured to the DLA_ADDR1 register, the local buffer address of the write-back information is configured to the DLA_ADDR2 register, and the stride block number is configured to the DLA_SIZE register through the second MCR instruction.

The stride block information includes the stride block number and the stride block size, wherein the stride block number is DLA_SIZE[15:0], which indicates the number of sets of the feature data; and the stride block size is fixed at 128 Bits (16 Bytes). Therefore, the feature data of this operation is the stride block number*the stride block size, that is, DLA_SIZE[15:0]*16 Bytes.

The Relu activation operator of the convolutional neural network is enabled through the CDP 0011 001 instruction, the input data is input to the Relu activation function

$$Relu ( X ) = \{ \begin{matrix}0 , & x < 0 \\ x , & x \geq 0\end{matrix}$$

according to the stride block information and the stride block size, and the result value is returned, wherein e is a natural constant in mathematics and x is the input data.

The result value is written back to the local buffer according to the write-back information.

In some embodiments, the step S104 of configuring the internal register through the MCR instruction, and then enabling the common basic operators through the CDP instruction, further includes:
configuring a local buffer address of a first vector set to a first register, configuring a local buffer address of a second vector set to a second register, configuring a local buffer address of write-back information to a third register, and configuring stride block information to a scale register through a third MCR instruction;
enabling the pooling operator of the convolutional neural network through the CDP instruction, comparing values in the first vector set and the second vector set one by one according to the stride block information, and returning a vector with a larger value from each comparison; and
writing a maximum pooling result obtained by the comparison back to a local buffer according to the write-back information.

Specifically, the local buffer address of the first vector set is configured to the DLA_ADDR1 register, the local buffer address of the second vector set is configured to the DLA_ADDR2 register, the local buffer address of the write-back information is configured to the DLA_ADDR3 register, and the stride block number is configured to the DLA_SIZE register through the third MCR instruction.

The stride block information includes the stride block number and the stride block size, wherein the stride block number is DLA_SIZE[15:0], which indicates the number of sets of the feature data; and the stride block size is fixed at 128 Bits (16 Bytes). Therefore, the feature data of this operation is the stride block number*the stride block size, that is, DLA_SIZE[15:0]*16 Bytes.

The pooling operator of the convolutional neural network is enabled through the CDP 0010 010 instruction, the values in the first vector set and the second vector set are compared one by one according to the stride block information, and the vector with the larger value is returned from each comparison. Element comparison operation may use be used for maximum pooling operation.

In addition, on the basis of configuring the internal register through the third MCR instruction, the values in the first vector set and the second vector set may be added one by one by using the CDP 0010 001 instruction according to the stride block information, and the obtained result is written back to the local buffer.

In some embodiments, the step S104 of configuring the internal register through the MCR instruction, and then enabling the common basic operators through the CDP instruction, further includes:
configuring a local buffer address of input data to a first register, configuring a local buffer address of write-back information to a second register, and configuring stride block information and table base address information to a scale register through a fourth MCR instruction;
enabling the table look-up operator of the convolutional neural network through the CDP instruction, and performing a table look-up operation according to the input data, the stride block information and the table base address information; and
writing a table look-up result back to a local buffer according to the write-back information.

Specifically, the local buffer address of the input data is configured to the DLA_ADDR1 register, the local buffer address of the write-back information is configured to the DLA_ADDR2 register, and the stride block number and the table base address information are configured to the DLA_SIZE register through the fourth MCR instruction.

The stride block information includes the stride block number and the stride block size, wherein the stride block number is DLA_SIZE[15:0], which indicates the number of sets of the feature data; and the stride block size is fixed at 128 Bits (16 Bytes). Therefore, the number of the feature data of this operation is the stride block number*the stride block size, that is, DLA_SIZE[15:0] *16 Bytes. DLA_SIZE[31:16] is a 16-bit table base address.

Four table look-up operators with table entries of 64/128/256/512 may be respectively enabled through the CDP 0100 000 instruction/CDP 0100 001 instruction/CDP 0100 010/CDP 0100 011, and the table look-up operations are performed according to the input data, the stride block information and the table base address information.

It should be noted that before the table look-up operation, the table to be looked up needs to be written in a fixed local buffer in advance, and then the table look-up operation is performed according to the input data and the table base address, and the obtained result is written back to the local buffer. Except Relu activation, other activation functions (such as tanh, sigmoid) may be realized by the table look-up operation. Using the table look-up method can realize a variety of different activation modes, which improves the flexibility.

In some embodiments, the step S104 of configuring the internal register through the MCR instruction, and then enabling the common basic operators through the CDP instruction, further includes:
configuring a local buffer address of input data to a first register, configuring a local buffer address of write-back information to a second register, and configuring stride block information to a scale register through a second MCR instruction; and
enabling the quantization operator of the cyclic neural network through the CDP instruction, and converting a 32-bit single-precision floating-point number conforming to an IEEE-754 standard in the input data into a 16-bit integer according to the stride block information, or converting a 16-bit integer in the input data into a 32-bit single-precision floating-point number conforming to the IEEE-754 standard; and writing a conversion result back to a local buffer according to the write-back information.

Specifically, the local buffer address of the input data is configured to the DLA_ADDR1 register, the local buffer address of the write-back information is configured to the DLA_ADDR2 register, and the stride block number is configured to the DLA_SIZE register through the second MCR instruction.

The stride block information includes the stride block number and the stride block size, wherein the stride block number is DLA_SIZE[15:0], which indicates the number of sets of the feature data; and the stride block size is fixed at 128 Bits (16 Bytes). Therefore, the feature data of this operation is the stride block number*the stride block size, that is, DLA_SIZE[15:0]*16 Bytes.

The quantization operator of the convolutional neural network is enabled through the CDP 0011 010 instruction or the CDP 0011 011 instruction, and the 32-bit single-precision floating-point number conforming to the IEEE-754 standard in the input data is converted into the 16-bit integer, or the 16-bit integer in the input data is converted into the 32-bit single-precision floating-point number conforming to the IEEE-754 standard according to the stride block information.

The conversion result is written back to the local buffer according to the write-back information.

In some embodiments, the method further includes:
configuring a main memory address to a first register, configuring a local buffer address to a second register, and configuring stride block information to a scale register through a fifth MCR instruction;
enabling a data reading operation through the CDP instruction, and reading data in the main memory address into the local buffer according to the stride block information; and
enabling a data writing operation through the CDP instruction, and writing data in the local buffer into the main memory address according to the stride block information.

Specifically, the main memory address is configured to the DLA_ADDR1 register; the local buffer address is configured to the DLA_ADDR2 register; and the stride block number, the stride block interval and the stride block size are configured to the DLA_SIZE register through the fifth MCR instruction.

The stride block information includes the stride block number, the stride block interval and the stride block size, wherein the stride block number is DLA_SIZE[15:0], which indicates the times of reading/writing; the stride block interval is DLA_SIZE[23:16], which indicates the interval between reads/writes, with a granularity of 32 Bits (4 Bytes), which indicates continuous access when it is configured as 0; otherwise, the actual stride size is (DLA_size [23: 16]+1)*4 Bytes. The stride block size is DLA_SIZE[25:24], which indicates the number of reads/writes each time. The block size is 4 Bytes when DLA_SIZE[25:24] is 2′d00, the block size is 8 Bytes when DLA_SIZE[25:24] is 2′d01, and the block size is 16 Bytes when DLA_SIZE[25:24] is 2′d10. Therefore, the feature data amount of this read/write operation is the stride block number*the stride block size, that is, DLA_SIZE[15:0]*DLA_SIZE[25:24].

The data reading operation is enabled through the CDP 0000 000 instruction, and the data in the main memory address is read into the local buffer according to the stride block information.

The data writing operation is enabled through the CDP 0000 001 instruction, and the data in the local buffer is written into the main memory address according to the stride block information.

It should be noted that the steps shown in the flow above or the flow chart of the accompanying drawings may be executed in a computer system such as a set of computer-executable instructions, and, although a logical sequence is shown in the flow chart, in some cases, the steps shown or described may be executed in a sequence different from the sequence herein.

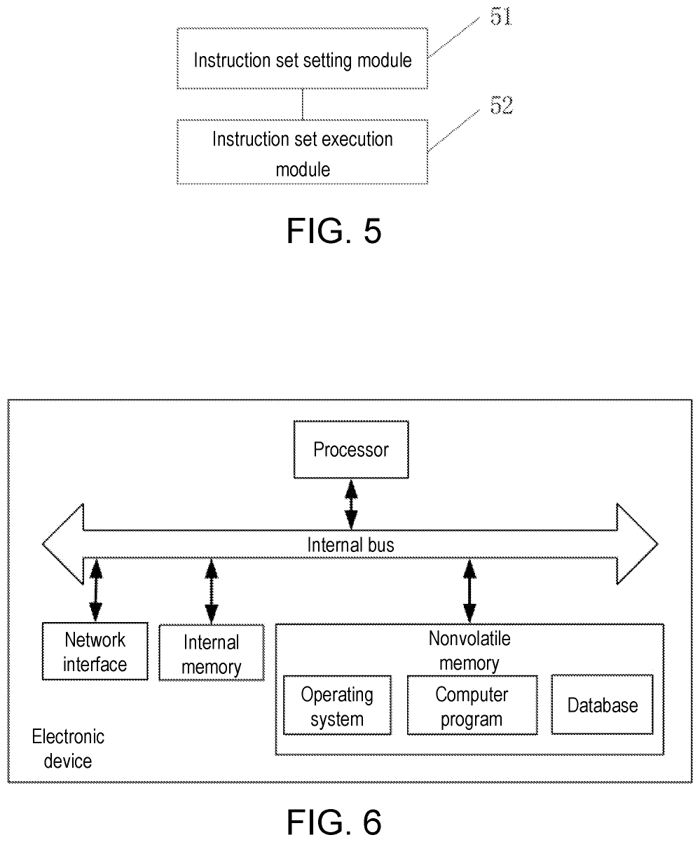

An embodiment of the present application provides a convolutional neural network acceleration system based on a Cortex-M processor. FIG. 5 is a structural block diagram of the convolutional neural network acceleration method based on the Cortex-M processor according to the embodiment of the present application. As shown in FIG. 5, the system includes an instruction set setting module 51 and an instruction set execution module 52.

The instruction set setting module 51 sets a MCR instruction and a CDP instruction according to common basic operators of a convolutional neural network, wherein the common basic operators include a convolution operator, a Relu activation operator, a pooling operator, a table look-up operator and a quantization operator.

The instruction set execution module 52 configures an internal register of a convolutional neural network coprocessor through the MCR instruction, and then enables the common basic operators of the convolutional neural network through the CDP instruction.

Through the instruction set setting module 51 and the instruction set execution module 52 in the embodiment of the present application, the problems of inefficiency, high cost and inflexibility of convolutional neural network algorithms in the execution of the processor are solved.

It should be noted that the above modules can be function modules or program modules, which can be realized by software or hardware. For modules implemented by hardware, the above modules may be located in the same processor; or the above modules may also be located in different processors in any combination.

This embodiment also provides an electronic device, including a memory and a processor, wherein the memory is stored with a computer program, and the processor is configured to run the computer program to execute the steps in any of the above method embodiments.

Optionally, the electronic device above may also include a transmission device and an input/output device, wherein the transmission device is connected with the processor above, and the input/output device is connected with the processor above.

It should be noted that for a specific example in this embodiment, reference may be made to the examples described in the foregoing embodiments and optional embodiments, which will not be elaborated in this embodiment.

In addition, in combination with the convolutional neural network based on the Cortex-M processor in the above embodiment, the embodiments of the present application may provide a storage medium for implementation. A computer program is stored on the storage medium. The computer program, when executed by a processor, realizes any one of the convolutional neural network acceleration method based on the Cortex-M processor in the above embodiments.

In one embodiment, a computer device is provided, and the computer device may be a terminal. The computer device includes a processor, a memory, a network interface, a display screen and an input device connected via a system bus. The processor of the computer device is configured for providing computing and control capabilities. The memory of the computer device includes a nonvolatile storage medium and an internal memory. The nonvolatile storage medium stores an operating system and a computer program. The internal memory provides an environment for the operation of the operating system and the computer program in the nonvolatile storage medium. The network interface of the computer device is used to communicate with external terminals through network connection. The computer program, when executed by a processor, realizes a convolutional neural network acceleration method based on a Cortex-M processor. The display screen of the computer device may be a liquid crystal display or an electronic ink display, and the input device of the computer device may be a touch layer covered on the display, or a key, a trackball or a touchpad arranged on a shell of the computer device, and may also be an external keyboard, an external touchpad or an external mouse, or the like.

In one embodiment, FIG. 6 is a schematic diagram of an internal structure of an electronic device according to an embodiment of the present application. As shown in FIG. 6, an electronic device is provided. The electronic device may be a server, and an internal structure diagram thereof may be shown in FIG. 6. The electronic device includes a processor, a network interface, an internal memory and a nonvolatile memory connected by an internal bus, wherein the nonvolatile memory stores an operating system, a computer program and a database. The processor is configured for providing calculating and control capabilities. The network interface is configured for communicating with external terminals through network connection. The internal memory is configured for providing an environment for the operation of the operating system and the computer program. The computer program, when executed by the processor, realizes a convolutional neural network acceleration method based on a Cortex-M processor is realized. The database is configured for storing data.

Those skilled in the art can understand that the structure shown in FIG. 6 is only a block diagram of some structures related to the solutions of the present application and does not constitute a limitation on the computer device to which the solutions of the present application is applied. The computer device may include more or fewer components than those shown in the figure, or may combine some components, or have different component arrangements.

Those of ordinary skills in the art should understand that all or a part of the flow of the methods in the above embodiments may be implemented by instructing relevant hardware through a computer program. The computer program may be stored in a nonvolatile computer-readable storage medium which, when being executed, may include the flow of the above-mentioned method embodiments. Any reference to the memory, storage, database or other media used in various embodiments provided by the present application may include nonvolatile and/or volatile memories. The nonvolatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external buffer memory. By way of illustration rather than limitation, the RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM) and a memory bus RAM (RDRAM), or the like.

It should be understood by those skilled in the art that the technical features of the above embodiments can be combined in any way. In order to simplify the description, not all the possible combinations of the technical features of the above embodiments are described. However, as long as there is no contradiction in the combinations of these technical features, they should be considered as the scope recorded in this specification.

The above embodiments merely express several embodiments of the present application, and the descriptions thereof are more specific and detailed, but cannot be understood as a limitation to the scope of the invention patent. It should be noted that those of ordinary skills in the art may make a plurality of decorations and improvements without departing from the conception of the present application, and these decorations and improvements shall all fall within the protection scope of the present application. Therefore, the protection scope of the patent according to the present application shall be subjected to the claims appended.

1. A convolutional neural network acceleration method based on a Cortex-M processor, wherein the method comprises:
setting a Master Control Reset (MCR) instruction and a Collection Due Process (CDP) instruction according to common basic operators of a convolutional neural network, wherein the common basic operators comprise a convolution operator, a rectified linear unit (Relu) activation operator, a pooling operator, a table look-up operator and a quantization operator; and
configuring an internal register of a convolutional neural network coprocessor through the MCR instruction, and then enabling the common basic operators of the convolutional neural network through the CDP instruction.

2. The method according to claim 1, wherein the step of configuring the internal register of the convolutional neural network coprocessor through the MCR instruction comprises:
configuring a data address, stride block information and format information of the internal register of the convolutional neural network coprocessor through the MCR instruction, wherein the data address is used for reading and writing data in operation, the stride block information is used for partitioning data in operation, and the format information is used for confirming an operation format and a write-back format of data.

3. The method according to claim 1, wherein the step of configuring the internal register through the MCR instruction, and then enabling the common basic operators through the CDP instruction, comprises:
configuring a local buffer address of a convolution kernel to a first register, configuring a local buffer address of feature data to a second register, configuring stride block information to a scale register, and configuring format information to a control register through a first MCR instruction;
enabling the convolution operator through the CDP instruction, and determining a preset channel number and a preset number of sets of the feature data in each operation according to the stride block information;
sequentially performing Multiply Accumulate operations on the feature data and the convolution kernel in a channel direction according to a total channel number and the preset channel number of the feature data; and
sequentially performing the Multiply Accumulate operations on the feature data and the convolution kernel in each of channels of the feature data in a preset direction according to a total number of the sets and the preset number of the sets of the feature data, and the format information until convolution results of all the channels are obtained.

4. The method according to claim 1, wherein the step of configuring the internal register through the MCR instruction, and then enabling the common basic operators through the CDP instruction, further comprises:
configuring a local buffer address of input data to a first register, configuring a local buffer address of write-back information to a second register, and configuring stride block information to a scale register through a second MCR instruction;
enabling the Relu activation operator of the convolutional neural network through the CDP instruction, inputting the input data to a Relu activation function
$$Relu ( X ) = \{ \begin{matrix}0 , & x < 0 \\ x , & x \geq 0\end{matrix}$$
according to the stride block information, and returning a result value, wherein e is a natural constant in mathematics and x is the input data; and
writing the result value back to a local buffer according to the write-back information.

5. The method according to claim 1, wherein the step of configuring the internal register through the MCR instruction, and then enabling the common basic operators through the CDP instruction, further comprises:
configuring a local buffer address of a first vector set to a first register, configuring a local buffer address of a second vector set to a second register, configuring a local buffer address of write-back information to a third register, and configuring stride block information to a scale register through a third MCR instruction;
enabling the pooling operator of the convolutional neural network through the CDP instruction, comparing values in the first vector set and the second vector set one by one according to the stride block information, and returning a vector with a larger value from each comparison; and
writing a maximum pooling result obtained by the comparison back to a local buffer according to the write-back information.

6. The method according to claim 1, wherein the step of configuring the internal register through the MCR instruction, and then enabling the common basic operators through the CDP instruction, further comprises:
configuring a local buffer address of input data to a first register, configuring a local buffer address of write-back information to a second register, and configuring stride block information and table base address information to a scale register through a fourth MCR instruction;
enabling the table look-up operator of the convolutional neural network through the CDP instruction, and performing a table look-up operation according to the input data, the stride block information, and the table base address information; and
writing a table look-up result back to a local buffer according to the write-back information.

7. The method according to claim 1, wherein the step of configuring the internal register through the MCR instruction, and then enabling the common basic operators through the CDP instruction, further comprises:
configuring a local buffer address of input data to a first register, configuring a local buffer address of write-back information to a second register, and configuring stride block information to a scale register through a second MCR instruction; and
enabling the quantization operator of the convolutional neural network through the CDP instruction, and converting a 32-bit single-precision floating-point number conforming to an IEEE-754 standard in the input data into a 16-bit integer according to the stride block information, or converting a 16-bit integer in the input data into a 32-bit single-precision floating-point number conforming to the IEEE-754 standard; and writing a conversion result back to a local buffer according to the write-back information.

8. The method according to claim 1, wherein the method further comprises:
configuring a main memory address to a first register, configuring a local buffer address to a second register, and configuring stride block information to a scale register through a fifth MCR instruction;
enabling a data reading operation through the CDP instruction, and reading data in the main memory address to a local buffer according to the stride block information;
and
enabling a data writing operation through the CDP instruction, and writing the data in the local buffer to the main memory address according to the stride block information.

9. A convolutional neural network acceleration system based on a Cortex-M processor, wherein the convolutional neural network acceleration system comprises an instruction set setting module and an instruction set execution module;
the instruction set setting module sets a MCR instruction and a CDP instruction according to common basic operators of a convolutional neural network, wherein the common basic operators comprise a convolution operator, a Relu activation operator, a pooling operator, a table look-up operator and a quantization operator; and
the instruction set execution module configures an internal register of a convolutional neural network coprocessor through the MCR instruction, and then enables the common basic operators of the convolutional neural network through the CDP instruction.

10. A computer-readable storage medium storing a computer program thereon, wherein the computer program is executed by a processor, implements the convolutional neural network acceleration method based on the Cortex-M processor according to claim 1.
